(19) United States
(12) Patent Application Publication
(10) Pub. No.: US 2011/0100215 A1
(43) Pub. Date: May 5, 2011

(54) Method and Apparatus for the Catalytic Reduction of Flue Gas NOx

(75) Inventors: Xiaotao Bi, Vancouver (CA); Tianxue Yang, Kenmore, NY (US)

(73) Assignee: The University of British Columbia, Vancouver, BC (CA)

(21) Appl. No.: 12/935,899

(22) PCT Filed: Mar. 31, 2009
(86) PCT No.: PCT/CA2009/000426

§ 371 Date: Dec. 27, 2010

Related U.S. Application Data
(60) Provisional application No. 61/064,869, filed on Mar. 31, 2008.

(51) Int. Cl. B01D 53/56; B01D 53/02

(52) U.S. Cl. 95/130; 422/168

(57) ABSTRACT

Described herein are a method and a reactor for reducing NOx contained in a gaseous emission stream. The method and the reactor both utilize an adsorption region in which NOx is adsorbed by either a catalyst material or a non-catalytic adsorbent material and a reduction region in which the adsorbed NOx is catalytically reduced by a hydrocarbon stream. Concentrations of components that inhibit catalytic NOx reduction, such as water vapour, oxygen, and sulphur dioxide, are lower in the reduction region than in the adsorption region. By adsorbing NOx in the adsorption region of the reactor and reducing NOx in the reduction region of the reactor, the reactor and method described herein allow for the efficient reduction of NOx from the emission stream even when the emission stream has a relatively high concentration of components that can inhibit efficient NOx reduction.

### FIELD

The present invention relates to the catalytic reduction of nitrogen oxide (“NOx”) from a flue gas or other emission stream.

### BACKGROUND

NOx is a generic term for the mono-nitrogen oxides NO and NO₂, and is a major air pollutant that generally results from combustion. Consequently, removing NOx from gaseous emission streams emanating from stationary (e.g.: electricity generation plants that use diesel, natural gas or other hydrocarbons as fuel) and mobile (e.g.: gasoline, diesel, or biodiesel combustion engines) sources is an important environmental goal. One major source of NOx is flue gases (gases emitted from a conduit that releases exhaust gases from a fireplace, oven, furnace, boiler or steam generator), which is one type of emission stream. However, as NOx results from combustion generally it can be found in all types of emission streams, regardless of whether such emission streams are flue gases.

The majority of known efficient methods for removing NOx from a gaseous emission stream involves using selective catalytic reduction (SCR) to reduce NOx to N₂ and H₂O via a catalyst with either ammonia (NH₃) or urea as a reducing agent. Though widely implemented, such methods suffer from several disadvantages; these include having to use and handle NH₃ (a toxic and corrosive chemical), and that NH₃ can react with sulfur oxides in the emission stream. The need to specially handle NH₃ and to avoid inadvertently discharging NH₃ into the environment adds complexity and cost to such methods. Furthermore, the reaction of NH₃ with sulfur oxides forms sulfates that foul downstream equipment, further complicating NOx removal.

To overcome these disadvantages, much research has been focused on using hydrocarbons as an alternative reducing agent. However, the performance of hydrocarbon-based SCR (HC-SCR) generally varies inversely with the amount of oxygen present in the emission stream, as the oxygen can react with the hydrocarbons in a chemical reaction that competes with the desired NOx reduction reaction. Additionally, in many combustion processes excess air or oxygen is introduced to the combustion process to ensure complete combustion; unfortunately, in addition to leading to excess oxygen in the emission stream, this also increases NOx formation rates, thus further reducing the HC-SCR efficiency by increasing the need for hydrocarbons.

While efforts have been made in recent years to improve HC-SCR, most such work has focused on using highly selective catalysts to promote NOx reduction while suppressing the competing hydrocarbon oxidation side-reaction that results from having relatively high oxygen levels in the emission stream. However, such highly selective catalysts have not been successfully used in typical real world operating conditions (e.g.: when the emission stream contains components such as water vapour, oxygen (O₂), and sulphur dioxide (SO₂)) with high levels of oxygen (e.g.: oxygen concentrations > about 2%).

Accordingly, there exists a need for a method and apparatus that can remove NOx from an emission stream that improves on the prior art.

### SUMMARY

According to one aspect of the invention, there is provided a method for reducing NOx contained in a gaseous emission stream. The method comprises:
passing the emission stream through an adsorption region of a reactor containing a solid adsorption material and contacting the NOx with the adsorption material such that the adsorption material adsorbs at least some of the NOx;
passing a gaseous hydrocarbon stream through a reduction region of the reactor, the reduction region containing a lower concentration of oxygen than the adsorption region (and optionally a lower concentration of water vapour and sulphur dioxide as well);
removing the adsorption material having the adsorbed NOx from the emission stream thereby producing a treated emission stream and transporting the adsorption material having the adsorbed NOx to the reduction region;
contacting the adsorption material having the adsorbed NOx and the hydrocarbon stream in the reduction region such that the adsorbed NOx is catalytically reduced by a catalytic material and the adsorption material is regenerated, the catalytic material being at least one of the adsorption material and a separate material that is located in the reduction region; and
returning the regenerated adsorption material to the adsorption region and discharging the treated emission stream from the reactor.

The emission stream and hydrocarbon stream can be passed vertically upwards through the reactor. In such case, the velocity of the hydrocarbon stream is high enough to carry the adsorption material having the adsorbed NOx upwards through the reduction region, and the velocity of the emission stream is low enough to allow adsorption material having the adsorbed NOx discharged from a top end of the reduction region to fall through the adsorption region and back into a bottom end of the reduction region, thereby removing the adsorption material having the adsorbed NOx from the emission stream and transporting the adsorbed material having the adsorbed NOx to the reduction region. In such case, the hydrocarbon stream can have a velocity of about 0.4 m/s to about 2.0 m/s and the emission stream has a velocity of about 0.2 m/s to about 0.6 m/s.

Alternatively, the velocity of the emission stream can be high enough to carry the adsorption material having the adsorbed NOx upwards through the adsorption region thereby removing the adsorption material having the NOx from the emission stream, and the velocity of the hydrocarbon stream is low enough to allow adsorption material having the adsorbed NOx discharged from a top end of the adsorption region to fall through the reduction region and back into a bottom end of the adsorption region, thereby transporting the adsorbed material having the adsorbed NOx between the adsorption region and the reduction region.

The reactor can have a temperature of between about 250° C. to about 550° C. Also, the emission stream can have an oxygen concentration of between about 2% to about 21%. The hydrocarbon stream can comprise a concentration of propylene or other hydrocarbons and the emission stream comprises a concentration of NO, the concentration of propylene or other hydrocarbons being about 1 to about 4 times (WV) the concentration of NO. The velocity of the emission and hydrocarbon streams can be selected so that the oxygen concentration in the reduction region is between 0.5 to 1.5%.

According to another aspect of the invention, there is provided a reactor for reducing NOx contained in a gaseous emission stream. The reactor comprises: a housing having a top end, bottom end, and a side wall interconnecting the top and bottom ends; a draft tube located inside the housing and spaced from the housing side wall to define an adsorption region therebetween and a reduction region inside the tube, the draft tube having an open top end and an open bottom end; a distribution plate inside the housing and extending from the side wall and downwards towards the draft tube bottom end; an emission stream inlet in the housing in gaseous communication with the bottom of the adsorption region such that a gaseous emission stream supplied through the emission stream inlet flows upwards through the adsorption region; a hydrocarbon stream inlet in the housing and in gaseous communication with the draft tube bottom end such that a gaseous hydrocarbon stream supplied through the hydrocarbon stream inlet flows upwards through the reduction region; adsorption material inside the housing that circulates between the reduction and adsorption regions when the emission and reduction streams are flowing through the reactor, and a reactor outlet located above and in gaseous communication with the draft tube top end and in gaseous communication with the adsorption region. The distribution plate is positioned so that adsorption material falling through the adsorption region are directed towards the draft tube bottom end and into the draft tube by the hydrocarbon stream. The reduction region can contain a catalyst material layered on a stationary substrate.

The reactor can also include a emission stream distribution chamber located under the distribution plate. The emission stream inlet is this case is in gaseous communication with the emission stream distribution chamber, and the distribution plate has at least one opening therethrough to allow the emission stream to pass from the emission stream distribution chamber to the adsorption region.

At least one opening in the distribution plate is located at a height in the reactor above the draft tube bottom end, to reduce the amount of gas sucked from the distribution plate opening to the draft tube bottom end. Further, the distribution plate can comprise a plurality of openings with a majority of the openings located at a height in the reactor above the draft tube bottom end; this allows the majority of the emission stream to flow upwards through the adsorption region with some of the emission stream being sucked into the reduction region to meet a desired oxygen content in the reduction region. Preferably, the oxygen content in the reduction region is between 0.5 to 1.5%.

According to another aspect of the invention, there is provided a reactor for reducing NOx contained in a gaseous emission stream, comprising: a housing having a top end, bottom end, and a side wall interconnecting the top and bottom ends; a draft tube located inside the housing and spaced from the housing side wall to define a reduction region therebetween and an adsorption region inside the tube, the draft tube having an open top end and an open bottom end; a distribution plate inside the housing and extending from the side wall and downwards towards the draft tube bottom end; a hydrocarbon stream inlet in the housing in gaseous communication with the bottom of the reduction region such that a gaseous hydrocarbon stream supplied through the hydrocarbon stream inlet flows upwards through the reduction region; an emission stream inlet in the housing and in gaseous communication with the draft tube bottom end such that an gaseous emission stream supplied through the emission stream inlet flow upwards through the adsorption region; adsorption material inside the housing that circulates between the reduction and adsorption regions when the emission and reduction streams are flowing through the reactor; and a reactor outlet located above and in gaseous communication with the draft tube top end and in gaseous communication with the reduction region. The distribution plate is positioned so that adsorption material falling through the reduction region will be directed towards the draft tube bottom end and into the draft tube by the emission stream. The reduction region can contain a catalyst material layered on a stationary substrate.

The invention has a variety of applications, including, for example, reducing NOx from the flue gas or emission streams of stationary power generating plants, mobile or portable power generating plants, and engines used for transportation purposes. The invention can be applied in scenarios wherein NOx emission control is desirable, and is particularly advantageous where relatively high oxygen concentrations (for example, > about 2%) are present in the flue gas or emission stream. Particular examples of applications include stationary power generation plants that use fuel such as diesel, natural gas or other hydrocarbons, and gasoline, diesel or biodiesel fuelled engines.

### BRIEF DESCRIPTION OF THE DRAWINGS

FIG. 1 is a schematic view of a dual-region reactor that can be used to catalytically reduce NOx from an emission stream, according to a first embodiment;

FIG. 2 is a schematic, sectional view of the dual-region reactor according to a second embodiment;

FIG. 3 is a schematic of a reactor system wherein the dual-region reactor is fluidly coupled to an emission stream source and a hydrocarbon stream source;

FIGS. 4(a)-(c) are graphs of NOx conversion vs. emission stream gas velocity for various velocities of a hydrocarbon stream for the second embodiment of the dual-region reactor;

FIG. 5 is a graph of NOx conversion vs. hydrocarbon velocity for a conventional fluidized bed reactor showing NOx conversion rates for emission streams containing various concentrations of oxygen, wherein the hydrocarbon/NOx ratio (V/V) is 1:1;

FIG. 6 is a graph of NOx conversion vs. hydrocarbon velocity for the conventional fluidized bed reactor showing NOx conversion rates for emission streams containing various concentrations of oxygen, wherein the hydrocarbon/NOx ratio (V/V) is 2:1;

FIG. 7 is a graph comparing NOx conversion rates for the dual-region reactor according to the second embodiment to conversion rates for a conventional fluidized bed reactor; and

FIG. 8 is a flowchart illustrating a method for catalytically reducing NOx from the emission stream, according to a third embodiment.

FIGS. 9(a) and 9(b) are a side elevation view and a top plan view, respectively, of a gas distributor plate that is used in the reactor according to the second embodiment.

### DETAILED DESCRIPTION OF EXEMPLARY EMBODIMENTS

One conventional way to remove NOx from an emission stream is to use a conventional fluidized bed reactor. A fluidized bed reactor has a single reaction region wherein a reductant, such as a hydrocarbon stream, can be injected into the reaction region at a velocity high enough to cause solid catalyst particles contained within the reaction region to fluidize, i.e. to behave as though the particles were a fluid. The emission stream is also injected into the reaction region, and the NOx contained therein can thereby be catalytically reduced into nitrogen gas and water.

However, using conventional fluidized bed reactors for NOx reduction has limitations. For example, most emission streams contain components such as oxygen, water vapour, and sulphur dioxide, all of which can reduce the efficiency with which the conventional fluidized bed reactor reduces NOx when such components are present in the same region of the reactor in which the NOx is being reduced.

The embodiments described herein describe a dual-region reactor and a method utilizing the dual-region reactor, the dual-region reactor having an adsorption region wherein NOx can be adsorbed from the emission stream and transported to a reduction region of the dual-region reactor wherein the NOx can be reduced. The reduction region can have fewer of the components such as oxygen, water vapour, and sulphur dioxide that reduce the efficiency of NOx reduction, and consequently can more efficiently reduce NOx from the emission stream than the conventional single-region fluidized bed reactor.

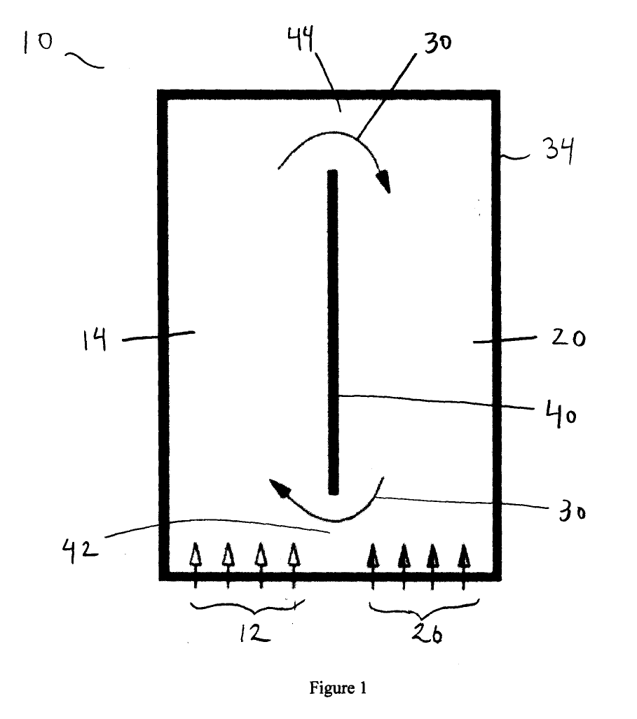

Referring now to FIG. 1, there is depicted a schematic view of a dual-region reactor 10 according to a first embodiment. The reactor 10 is made of a reactor housing 34 that has a partition plate 40 mounted therein. The partition plate 40 is spaced from the reactor housing 34 such that gaps between the ends of the partition plate 40 and the reactor housing 34 define an inlet aperture 42 and an outlet aperture 44. The partition plate 40 also divides the reactor housing 34 into two regions or zones: an adsorption region 14 defined by one half of the reactor housing 34 and the partition plate 40, and a reduction region 20 defined by the other half of the reactor housing 34 and the partition plate 40. During operation, a gas distributor (not shown in FIG. 1) is used to distribute a flue gas or other emission stream 12 through the adsorption region 14, and to introduce the hydrocarbon stream through the reduction region 20. The emission stream 12 and the hydrocarbon stream are passing through the adsorption region 14 and the reduction region 20 at different velocities, which results in a pressure differential between the adsorption and reduction regions 14, 20. In FIG. 1, the emission stream 12 velocity is higher than the hydrocarbon stream velocity, and this causes an adsorption material 32 in the form of a particulate catalyst material to be drawn into the adsorption region 14 through the inlet aperture 42. The catalyst material is supported at sufficient gas velocity within the reactor housing 34 such that it is fluidized, and because it is fluidized, catalyst particles move upward in the adsorption region 14 and exit the adsorption region 14 through the outlet aperture 44. The pressure differential between the adsorption and reduction regions 14, 20 leads to circulation of the particulate catalyst material between the regions 14, 20.

In FIG. 1, the catalyst material flows upwards in the adsorption region 14 and downwards in the reduction region 20. The velocity of the emission stream 12 is greater than the terminal settling velocity of a single particle of the catalyst material; consequently, the particulate catalyst material rises in the adsorption region 14. The velocity of the hydrocarbon stream is less than the terminal settling velocity of a single particle of the catalyst material; consequently, the particulate catalyst material is pulled downwards by gravity and falls in the reduction region 20. By adjusting the velocities of the emission stream 12 and the hydrocarbon stream such that the velocity of the emission stream 12 is lower than the terminal settling velocity of a single particle of the catalyst material and such that the velocity of the hydrocarbon stream is higher than the terminal settling velocity of a single particle of the catalyst material, the direction of circulation of the catalyst material can be reversed such that the catalyst material flows upwards in the reduction region 20 and downwards in the adsorption region 14.

By virtue of the pressure differential between the adsorption and reduction regions 14, 20, a circulating loop 30 composed of the catalyst material continuously circulates between and through the reduction region 20 and the adsorption region 14 while the reactor 10 is operating. The circulating loop fluidly couples the adsorption and reduction regions 14, 20 together such that the catalyst material circulates between and through the adsorption and reduction regions 14, 20 continuously. The catalyst material enters the adsorption region 14 from the reduction region 20 through the inlet aperture 42 and enters the reduction region 20 from the adsorption region 14 through the outlet aperture 44. In the adsorption region 14, NOx is adsorbed by the catalyst material (or, alternatively, by a non-catalytic adsorbent material) when the emission stream 12 containing NOx contacts the catalyst material. In the reduction region 20, NOx is reduced by the hydrocarbon stream when the hydrocarbon stream contacts the catalyst material having NOx adsorbed thereon, thereby catalytically reducing the NOx. When the emission stream 12 and consequently the adsorption region 14 contain high concentrations of oxygen, sulphur dioxide, water vapour, or other components that can decrease NOx reduction efficiency, the catalyst material can beneficially adsorb the NOx in the adsorption region 14 and transport the adsorbed NOx to the reduction region 20, where such components are either not present or present in significantly lower concentrations than in the adsorption region 14. Consequently, the efficiency with which the reactor 10 can reduce NOx from the emission stream 12 is greater than that of a conventional single-zone fluidized bed reactor. In the reduction region 20, the adsorbed NOx can be catalytically reduced, which regenerates the adsorption material 32. The adsorption material 32 can then be recirculated back to the adsorption region 14 where it can again adsorb NOx and the process can repeat.

In this embodiment, the adsorption material 32 and the catalyst material are identical, although this is not necessary for all embodiments. For example, the adsorption material 32 may be a non-catalytic particulate, and the catalyst material may be contained within the reduction region 20 layered on a stationary substrate, as in an automobile catalytic converter. Typical catalysts that can be used include base metals, base metal oxides, precious metals, Cu-Beta, Cu-ZSM-5, Fe/ZSM-5, CAT-1, V2O5/Al2O3, and Co-FER. Examples of solely adsorbent, non-catalytic particles include activated carbon, zeolite and BaO particles. The hydrocarbon stream may be composed of, for example, any of alkanes, alkenes, alcohols, organic acids, synthetic hydrocarbons, and petroleum-based hydrocarbons.

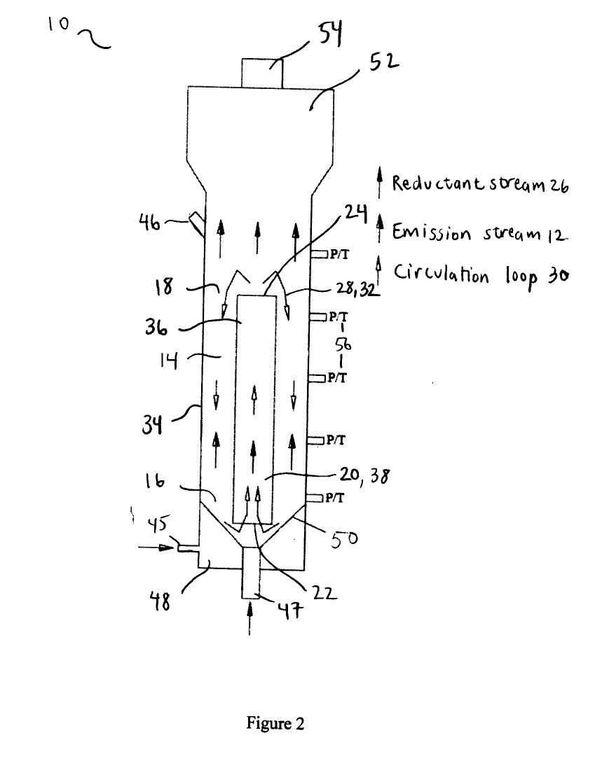

Referring now to FIG. 2, there is depicted a schematic, sectional view of the reactor 10 according to a second embodiment. The reactor 10 has a generally cylindrical reactor housing 34 having a bottom end, a top end, and an interconnecting side wall. A reductant stream inlet 47 is disposed at the housing bottom end and extends inside the housing 34. An emission stream distribution chamber 48 is located at the bottom of the interior of the housing 34 and is constrained by the bottom end and side wall of the housing 34, and by a funnel-shaped gas distributor plate 50, the top of which is attached to the housing side wall and the bottom of which is attached to the top of the reductant stream inlet 47 such that the reductant stream inlet 47 is not in fluid communication with the emission stream distribution chamber 48. An emission stream inlet 45 is disposed near the bottom of the housing side wall and into the emission stream distribution chamber 48. A draft tube 36 is mounted inside the housing 34 (mounting brackets not shown) and has an open top end which is spaced from the housing top end, and an open bottom end which is closely spaced from the distributor plate 47. The draft tube 36 is also spaced from the housing side wall to define an annular space therebetween. The distributor plate 50 is porous to permit gaseous communication between the emission stream distribution chamber 48 and into the annular space. A bottom opening 22 of the draft tube 36 is aligned with and in close proximity to the reductant stream inlet 47, such that the bottom opening 22 of the draft tube 34 is in gaseous communication with gases discharged from the reductant stream inlet 47 as well as with the annular space immediately above the distributor plate 50.

The annular space above the emission stream distribution chamber 48 is hereinafter referred to as the adsorption region 14. The top of the draft tube 36 terminates below the top end of housing 34; the space inside the housing between the top of the draft tube 36 and the top end is hereinafter referred to as the freeboard region 52. The space inside the draft tube 36 is hereafter referred to as the reduction region 20.

A solids inlet 46 is disposed in the housing side wall and is in communication with the freeboard region 52. A reactor outlet 54 is disposed in the housing top end and also is in communication with the interior of the housing 34. Inside the housing 34 and spaced along the housing side wall between the emission stream inlet 45 and the solids inlet 46 are a plurality of temperature and pressures sensors 56; the sensors 56 are communicative with a controller (not shown) to send collected pressure and temperature data to the controller for processing.

In operation, the reactor 10 receives a reductant stream 26 in the form of a hydrocarbon stream at a selected pressure and flow rate through the reductant stream inlet 47 and mostly into the reduction region 20 of the draft tube 47 (provided the pressure differential between the reductant and emission streams are within a selected range, there should only be a relatively insignificant amount of hydrocarbon stream that will be discharged into the adsorption region 12), wherein the hydrocarbon stream reacts with adsorbed NOx in the reduction region 20. The reactor 10 receives an emission stream 12 in the form of a flue gas comprising air, water vapour, sulphur dioxide and NOx through the emission stream inlet 45 and into the emission stream distribution chamber 48, which then is evenly distributed into the adsorption region 14 by the distributor plate 50. The emission stream 12 is provided at a selected pressure and flow rate that is different from the hydrocarbon stream pressure and flow rate. The adsorption material 32, which is a catalyst material selective to NOx—hydrocarbon reduction reaction is injected into the reactor 10 via the solids inlet 46. A solids outlet (not shown) is disposed at the bottom of the reactor 10 to allow the adsorption material 32 and the catalyst material to be removed from the reactor 10.

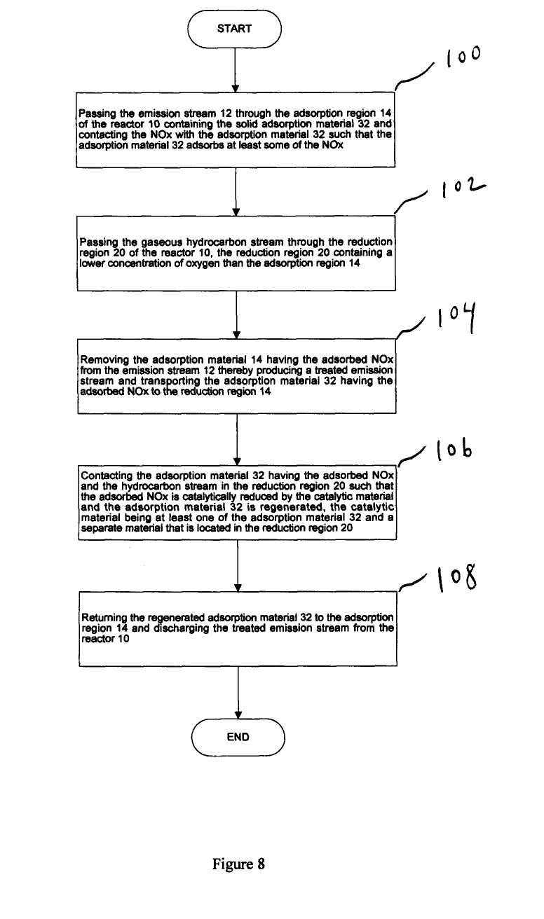

As will be described in detail below in reference to FIG. 8, the catalyst material 32 during operation of the reactor 10 will circulate through the adsorption region 14 in the emission stream 12 and will adsorb NOx from the emission stream 12. The catalyst material having NOx adsorbed thereon will then enter the reduction region 20 inside the draft tube 36 via the bottom opening 22 of the draft tube 36 and circulate with the hydrocarbon stream in the reduction region 20. In the reduction region 20, the adsorbed NOx is reduced by the hydrocarbon stream to produce reaction products such as nitrogen and water, and the catalyst material is regenerated. The regenerated catalyst material 32 is then carried up by the hydrocarbon stream and is discharged from a top opening 24 of the draft tube 36 and then falls back into the adsorption region 14. As indicated by the arrows in FIG. 2, during operation the emission stream 12 and the hydrocarbon stream are continuously passed through the adsorption and reduction regions 14, 20, respectively. The adsorption material 32 forms the circulating loop 30 that extends through and is in fluid communication with the adsorption and reduction regions 14, 20. The path of the circulating loop 30 is also indicated in arrows in FIG. 2.

The treated emission stream 12 (less the reduced NOx), unreacted components of the hydrocarbon stream and various reaction products exit the adsorption and reduction regions 14, 20 and travel through the freeboard region 52 and out of the reactor 10 via the reactor outlet 54. Since gas velocity in the freeboard region 52 is substantially lower than the terminal settling velocity of the catalyst material, the particulate catalyst material is not entrained out of the reactor 10.

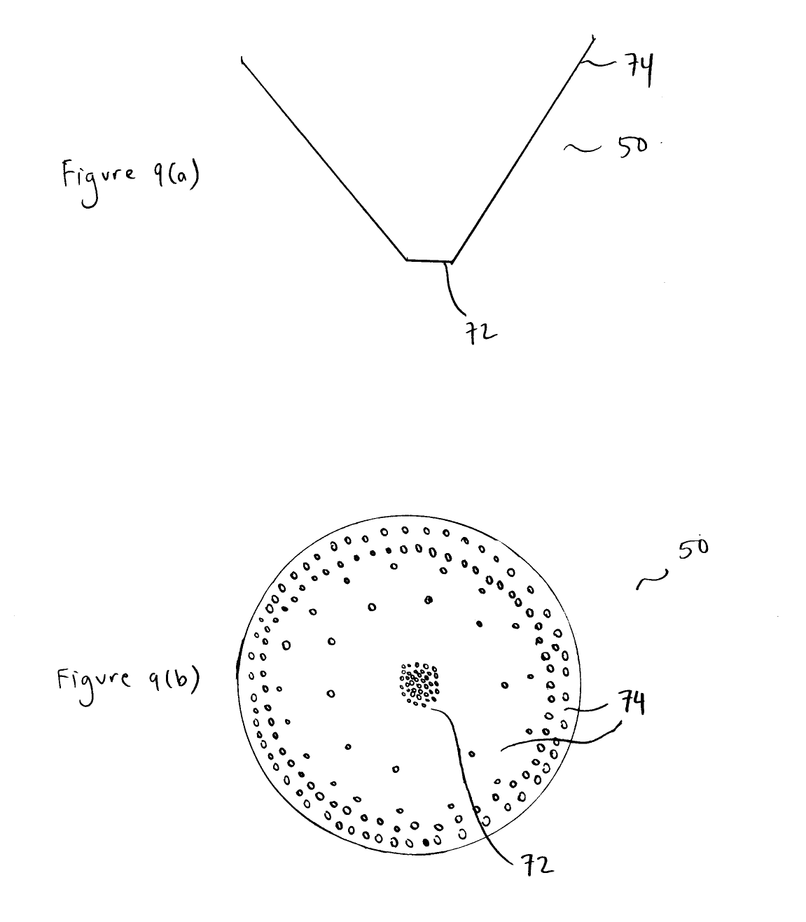

The velocity of the hydrocarbon stream within the draft tube 36 is higher than the velocity of the emission stream 12 within the reduction region 20. This creates a pressure differential that helps to draw in the particulate catalyst material from the reduction region 20 into the draft tube 36. As with the first embodiment of the reactor 10, the design velocity of the hydrocarbon stream in the reduction region 20 is selected to be greater than the terminal settling velocity of a particle of the catalyst material so that the catalyst material will rise in the draft tube 36 and be discharged from the open top end of the draft tube 36. The design velocity of the emission stream 12 in the adsorption region 14 is selected to be less than the terminal settling velocity of a particle of the catalyst material so that the catalyst material will fall in the adsorption region 14. When the catalyst material has fallen to the bottom of the adsorption region 14, it hits the distributor plate 50 and slides downwards towards the central distribution of holes 74 (illustrated in FIG. 9(b), below) towards the bottom opening 22 of the draft tube, wherein the hydrocarbon stream will transport the catalyst material back into the draft tube 36. In this way, a continuous circulation of catalyst material is maintained.

Referring now to FIGS. 9(a) and 9(b), there are depicted side elevation and top plan views of the gas distributor plate 50 that is used in the reactor 10 according to the second embodiment. The gas distributor plate 50 is funnel-shaped and includes two groupings of holes. A first annular distribution of holes 72 is generally disposed along the periphery of the distributor plate 50 and is located at a height in the reactor that is above the open bottom end of the draft tube 36. The second central distribution of holes 74 is generally centrally disposed within the distributor plate 50 and is located in the reactor at a height that is below the bottom opening 22 of the draft tube 36. This layout of holes 72, 74 are selected so that when the emission stream 12 and the hydrocarbon stream are supplied to the reactor 10 at their designed flow rates, the part of the emission stream 12 flowing through the annular distribution of holes 72 will substantially flow upwards though the adsorption region, and the part of the emission stream flowing through the central distribution of holes 74 will be sucked by the faster flowing hydrocarbon stream into the draft tube 36 via the bottom opening 22.

The annular distribution of holes 72 is spaced on the distributor plate 50 such that a limited amount of the emission stream 12 exiting through the annular distribution of holes 72 enters the draft tube 36. The amount of oxygen in the emission stream 12 can vary, but typically ranges from 4% -15%. Experiments have been performed (see experimental data presented below) which indicate that oxygen levels of 4% or more can significantly impede the efficiency at which NOx is reduced (“conversion efficiency”), as the oxygen competes with the NOx to react with the hydrocarbon stream. Therefore, the reactor 10 is operated so that the oxygen content in the reduction region 20 is below the oxygen content in the adsorption region 14.

However, it has also been determined that in most cases, some amount of oxygen in the reduction region 20 is present; most of the NOx species in the emission stream tends to be nitric oxide (NO) which preferably should be reacted with oxygen to form nitrogen dioxide (NO₂) before reduction by the hydrocarbon stream. Therefore, the reactor is preferably operated so that the oxygen content in the reduction region 20 is kept to a level of 1% +1-0.5%. This level is sufficient to enable hydrocarbon reduction of NOx without having oxygen significantly compete with the NOx for the hydrocarbon stream. The preferred level of oxygen in the reduction region 20 can be obtained by selecting the flow rates of the emission stream 12 and the hydrocarbon stream such that a specific pressure differential is achieved by the faster flowing hydrocarbon stream to suction a sufficient amount of the emission stream 12 containing the requisite amount of oxygen into the draft tube 36. While the hole pattern 72, 74 of the distribution plate 50 is selected to assist in diverting the appropriate amount of emission gas into the draft tube 36, the hole pattern can be varied to allow for a different range of operating velocities of the emission and hydrocarbon streams.

Furthermore, by limiting the amount of the emission stream 12 that enters the reduction region 20, the amount of water vapour and sulphur dioxide (components of the emission stream 12) that enter the reduction region 20 is controlled. Water vapour and sulphur dioxide are undesirable in that they can poison the catalyst material, and limiting their presence in the reduction region 20 therefore promotes a high NOx conversion efficiency. Therefore, the reactor 10 is preferably operated so that the water vapour and sulphur dioxide content in the reduction region 20 is less than in the adsorption region 14.

By providing the draft tube 36 and selecting a suitable differential in flow rates between the hydrocarbon stream and emission stream 12, two functionally separate adsorption and reduction regions 14, 20 can be maintained. In practice, there will be some intermixing of the hydrocarbon stream in the adsorption region 14 and some emission gas in the reduction region 20 due to the bypassing of the emission stream 12 into the reduction region 20 and the hydrocarbon stream into the adsorption region 14, but functionally, there is sufficient separation between these gases that a NOx reduction reaction can occur in the reduction region 20 relatively efficiently, i.e. with a sufficiently reduced amount of the components in the emission stream that impede the reduction reaction (e.g. oxygen, water vapour, and sulphur dioxide), and such that the catalyst or other adsorption material 32 can adsorb NOx in the adsorption region 14. Performance of the reactor 10 has generally found to be better when the velocity of the stream in the draft tube 36 exceeds that of the emission stream 12, regardless of whether the hydrocarbon stream is disposed within the draft tube 36 or in the annular space.

While the draft tube 36 is shown in this embodiment, the partition plate 40 or any other means for creating two regions within the reactor 10 through which the emission stream 12 and the reductant stream 26 can be passed and that allows for the circulating loop 30 to flow through and between the adsorption and reduction regions 14, 20 may be used, as is known to persons skilled in the art. Modifying the draft tube 36 or whatever means for creating two regions within the reactor 10 is used, and modifying the gas distributor plate 50, are ways in which the amount of the emission stream 12 that enters the reduction region 20 or the amount of the hydrocarbon stream that enters the adsorption region 14 can be controlled to create the optimal oxygen concentration in the reduction region 20 while maintaining a high solids (i.e.: catalyst material or non-catalytic adsorption material) circulation rate. Both flat plate and conical, or funnel-shaped, distributor plates 50 can be used.

For a given distributor plate 50 design, by adjusting the flow rate of one or both of the emission stream 12 and the hydrocarbon stream, and in particular the differential flow rates between the two streams 12, 26 the amount of the emission stream 12 that is undesirably diverted into the draft tube 36 can be controlled, and the oxygen concentration in the reduction region 20 can be maintained at desired levels. Exemplary operating parameters with respect to the temperature of the reactor 10 and the velocity of the emission stream 12 and the hydrocarbon stream are discussed in more detail, below.

The specific performance of the reactor 10 will depend on factors such as the reactor's 10 physical characteristics (e.g.: its dimensions, partition design that divides the reduction region 20 from the adsorption region 14, the cross-sectional areas of the adsorption and reduction regions 14, 20 and the design of the gas distributor plate 50); the nature of the catalyst material (e.g.: what type of support or substrate material is used and what type of catalyst is used, particle size, aggregate reaction surface area available); the reducing agent used (e.g.: type and source); and the components of the emission stream 12 (e.g.: which chemicals are present, and in what concentrations); and the flow rates of the emission stream 12, the hydrocarbon stream, and the hydrocarbon-to-NOx flow ratio. All of these parameters can be considered in optimizing performance of the reactor 10.

Referring now to FIG. 8, there is depicted a flowchart illustrating a method for catalytically reducing NOx from the emission stream 12, by the reactor 10 shown in FIG. 2. While this method is described with reference to the reactor 10 shown in FIG. 2, the method can be used with the reactor of FIG. 1, as well as with other suitable dual-region reactor designs.

At block 100, the emission stream 12 is first passed through the emission stream inlet 45 and into the adsorption region 14 of the reactor 10 at a selected pressure and flow rate. The emission stream flows upwards inside the adsorption region 14, and the emission stream 12 contacts the adsorption material 32 circulating in the adsorption region 14 such that the adsorption material 32 adsorbs the NOx. The reductant stream 26, typically the hydrocarbon stream, is passed through the reduction region 20 via the reductant stream inlet 47 and draft tube 36 (block 102) at a selected pressure and flow rate that is different from the emission stream pressure and flow rate. The adsorption material 14 having the adsorbed NOx thereon flows to the reduction region 20 via the bottom opening 22 as a result of the flow rate differential between the emission and reduction streams (block 104). The adsorption material 32 having the NOx adsorbed thereon and having catalytic properties is catalytically reduced by the reductant stream 26 (block 106); this regenerates the adsorption material 32 such that it can be returned to the adsorption region 14 to adsorb more NOx. Alternatively, the adsorption material can be separate from the catalytic material; the catalyst material can be provided in the reduction region 20 (e.g. be fixed on a screen in the reduction region), and the adsorption material 32 can be a material that does not have catalytic properties and which circulates in the emission and reductant streams 12, 26 between the adsorption and reduction regions 14, 20; therefore, the reduction reaction will occur when adsorbed NOx on the adsorption material 32 encounters both the catalyst material and the hydrocarbon stream in the reduction region 20.

Following reduction, reduction reaction products are transported from the reduction region 20 into the freeboard region 52 and out of the reactor 10 via outlet 54. Regenerated adsorption material 32 flows from the reduction region 20 back into the adsorption region 14 (block 108) again as a result of the flow rate differentials between the emission and reduction streams. As discussed above in respect of the first and second embodiments, by adsorbing NOx in the adsorption region 14 where concentrations of components such as water vapour, oxygen, and sulphur dioxide can be relatively high and by reducing NOx in the reduction region 20 where concentrations of such components are lower, the reduction process can be made significantly more efficient. Also as discussed in the above embodiments, the adsorption material 32 and the catalyst material can be identical.

Certain operating parameters have been found to result in particularly beneficial or advantageous performance of the method. Such parameters include operating the reactor 10 when the reactor 10 is at a temperature of between about 250° C. to about 550° C.; when the emission stream 12 has an oxygen concentration of between about 2% to about 21%; when the reductant stream 26 is composed of a concentration of propylene and the emission stream is composed of a concentration of NO, the concentration of propylene being about 1 to about 4 times (V/V) the concentration of NO; and when the reductant stream 26 has a velocity of about 0.4 m/s to about 2.0 m/s and the emission stream 12 has a velocity of about 0.2 m/s to about 0.6 m/s for a particulate catalyst material having a mean diameter of about 0.15 mm.

Experimental Data

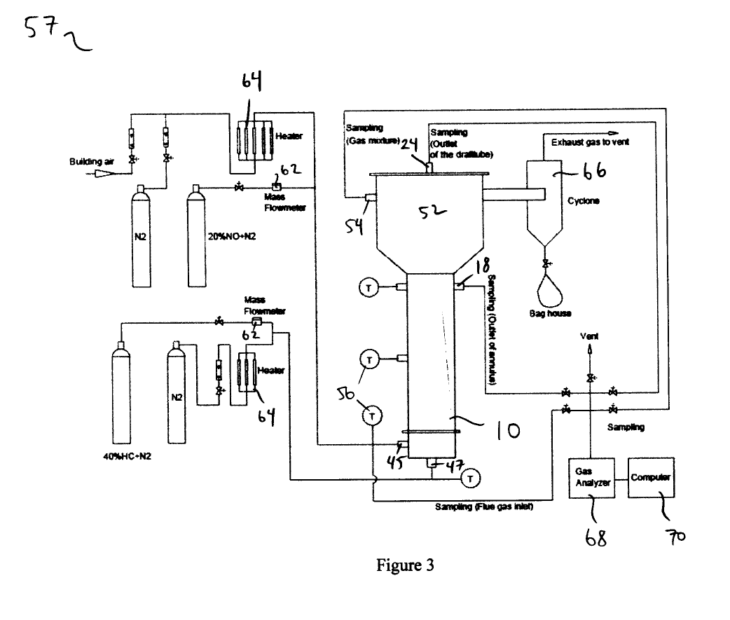

The reactor 10 according to the second embodiment, as described above and as depicted in FIG. 2, was tested using the system 57 depicted in FIG. 3. The emission stream 12 was a NO source mixed with pure nitrogen gas and building air. The reductant stream 26 was a hydrocarbon stream composed of propylene mixed with preheated nitrogen gas. The model emission stream 12 was injected into the adsorption region 12 of the reactor 10 and the hydrocarbon stream was injected into the reduction region 20 of the reactor 10. The reactor 10 used a particulate catalyst material both as the catalyst and as the adsorbent material 32. NOx reduction performance was evaluated by measuring gas components at the adsorption region inlet 16 and adsorption region outlet 18, the top opening 24, and at the reactor outlet 54. A gas analyzer 68, cyclone 66, and computer 70 were used to measure performance of the reactor 10. By adjusting the flow rate of one or both of the emission stream 12 and hydrocarbon stream, the gas bypassing rates between the adsorption region 14 and the reduction region 20 were calculated. Heaters 64 and mass flowmeters 62 were used to regulate and monitor system performance. For all experiments discussed below, the reactor 10 operated in a temperature range of about 340° C. to about 360° C. or 340° C. to about 370° C.

Various dimensions of the reactor 10 used in the experimental testing are listed in Table 1, below:

TABLE 1
Dimensions of the Reactor 10 Used in Experimental Tests

| Item | Dimension |
|---|---|
| Draft tube 36 diameter | 2.157″ (inner); 2.375″ (outer) |
| Draft tube 36 length | 40″ |
| Reactor column (portion of reactor 10 | 4.26″ (inner); 4.5″ (outer) |
| below the freeboard 52) diameter | |
| Reactor column height | 43.0″ |
| Freeboard 52 height | 40.0″ |
| Freeboard 52 diameter | 10.25″ (inner); 10.75″ (outer) |
| Annulus (reduction region 20) | 1.62%; 52 holes with 1/16″ diameter |
| distributor 50 opening rate | |
| Reductant stream inlet 47 (hydrocarbon | 1 ⅜″ (inner); 1.5″ (outer) |
| nozzle) diameter | |
| Reductant stream distributor plate | 9.19%, 61 holes with 1/16″ diameter |
| 50 opening grate | |

The gap between the bottom of the draft tube 36 and the top of the distributor plate 50 is about 10 mm to about 15 mm.

For the current configuration with 0.155 mm diameter catalyst particles, the desirable gas velocity in the draft tube 36 is about 0.75 m/s to about 1.2 m/s, while the desirable gas velocity in the annular adsorption region 14 is about 0.2 m/s to about 0.6 m/s. The circulation rate of the catalyst material was found to increase with increase draft tube velocity.

Catalyst Preparation

For these experiments, Fe/ZSM-5 was chosen as the catalyst material and Na/ZSM-5 was selected as a catalyst support material. The catalyst material had the following properties: 155 micron average particle size, 968 kg/m³ apparent bulk density, and surface area (SBET) of 190 m²/g. The catalyst was prepared as described below.

Materials

The following materials were used to prepare the catalyst material:
Ammonium nitrate: NH₄NO₃, 99.0%, Sigma-Aldrich
Iron (III) acetylacetonate: (Fe(AA)₃)) 97%, Sigma-Aldrich
Toluene>=99.5%, Sigma-Aldrich
Deionized water

Preparation of H/ZSM-5

H/ZSM-5 was prepared from Na/ZSM-5 by ion exchange with NH₄NO₃ solution. 1,000 g of Na/ZSM-5 was mixed with 1 L of 0.5 M NH₄NO₃ solution at room temperature, and the slurry was stirred periodically. After 3 hours, the catalyst material in the slurry was separated from the NH₄NO₃ solution, and mixed with another batch of fresh 0.5 M NH₄NO₃ solution (1 L). After performing the aqueous ion-exchange process 3 times, the catalyst material was washed thoroughly with 1 L of deionized water 3 times, dried at 120° C. for 12 hours, and then calcined in air at 500° C. for 4 hours.

Preparation of Fe/ZSM-5

Fe/ZSM-5 was prepared from the H/ZSM-5 obtained above by the impregnation method. 560 g of H/ZSM-5 was added to a solution containing 200 g Fe(AA)₃ and 800 mL toluene. The slurry was stirred periodically for 24 hours. Toluene was then evaporated from the slurry and recycled, and the residue after the evaporation was dried in air at 120° C. for 12 hours and calcined in air at 500° C. for 4 hours. The obtained Fe/ZSM-5 catalyst contained 5.65% (wt.) of Fe.

Model Emission Stream (Flue) Gases

The model emission stream 12 used in the experiments was a mixture prepared from the following gas sources: 20% NO balanced with N₂ from cylinder and liquid N₂ dewars from Praxair Products Inc. Building air was used as the source of O₂. NO concentration in the model flue gas was controlled to ˜600 ppm with O₂ concentration from 4 to 12%.

Reducing Agent

The reducing agent used in the experiment was propylene. The gas cylinder containing 40% propylene balanced with N₂ was supplied by Praxair Products Inc. The reductant stream 26 consisted of propylene+N₂, with propylene concentration of 1 to 4 times (V/V) of NO in the emission stream 12.

Experimental Results

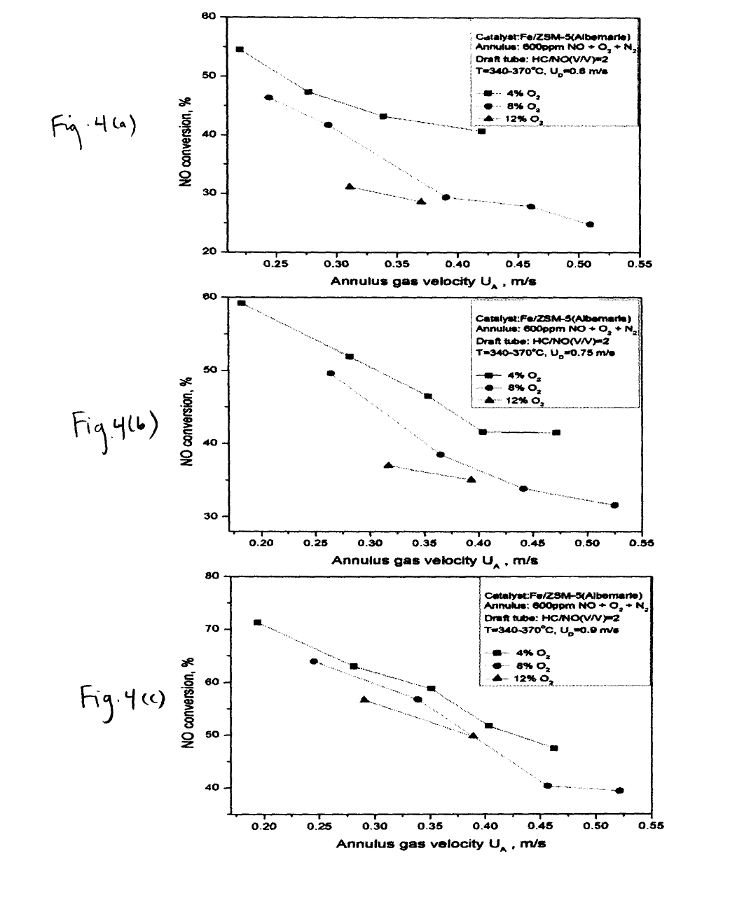

The performance of the dual-region reactor 10 was compared to the performance of a conventional, single-region fluidized bed reactor under a variety of conditions, as illustrated in the graphs of FIGS. 4 through 7. Both the reactor 10 and the conventional fluidized reactor were used to perform HC-SCR of NO. In particular, the effects of the oxygen concentration on the performance of the different systems are described. The conventional fluidized bed reactor had a gas distributor opening rate of 3.25%, 151 holes with 1/16″ diameter.

Effect of O₂ Concentration on the Dual-Region Reactor 10 Performance

The influence of O₂ on NO conversion with hydrocarbon(HC):NO=2 is shown in FIGS. 4(a)-(c) for different draft tube 36 superficial gas velocities (U_{D}); i.e., for different reduction region 20 gas velocities. For a given U_{D}, with the increase of O₂ concentration, the NO conversion decreased. When U_{D} increased from 0.6 to 0.9 m/s, the same trend was observed. However, the difference between various O₂ concentrations decreased as U_{D} increased; thus the increasing O₂ concentration has less influence on NO conversion at higher U_{D}. In other words, higher U_{D} is preferable for NO conversion when O₂ concentration in the model flue gas is at a relatively high level.

Effect of O₂ Concentration on Conventional Fluidized Bed Reactor

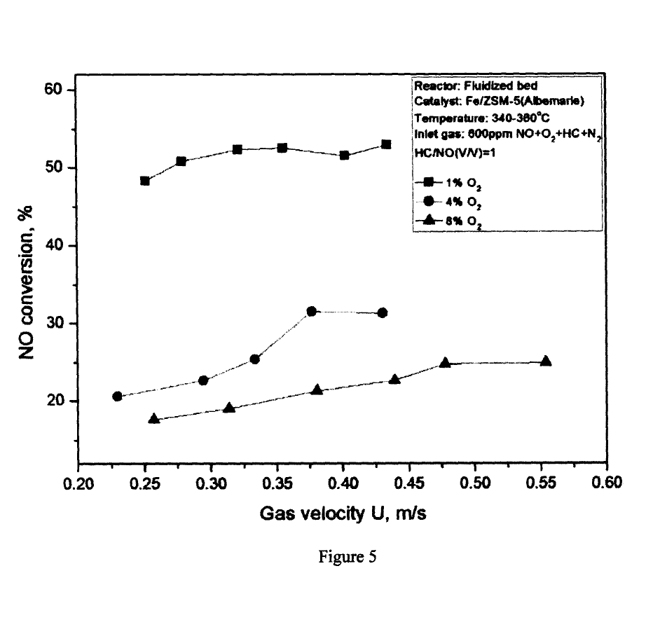

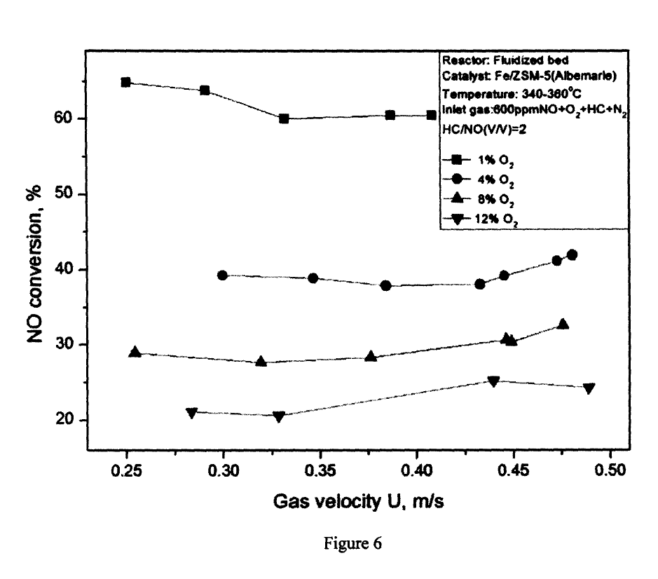

The influence of O₂ concentration on the catalytic activity of Fe/ZSM-5 in the conventional fluidized bed is shown in FIGS. 5 and 6 (at different hydrocarbon:NO, or HC:NO, ratios). In these cases, the increase of gas velocity has less influence on NO conversion than in the dual-region reactor 10. However, increasing O₂ concentration showed significant negative impact on NO conversion.

When the HC:NO ratio increased from 1 (FIG. 5) to 2 (FIG. 6), the NO conversion improved by 10% compared to HC:NO=1 at the same O₂ concentration. Changes in the gas velocity also had no significant influence on NO conversion for a fixed O₂ concentration.

Comparison Between the Dual-Region Reactor 10 and the Conventional Fluidized Bed Reactor

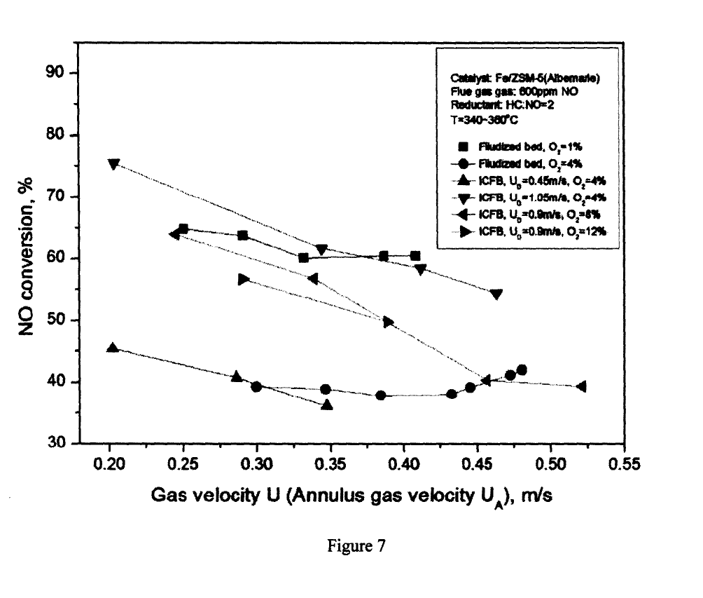

FIG. 7 compares the NO conversion in the conventional fluidized bed with that in the dual-region reactor 10. For O₂=4%, U_{D}=0.45 and 1.05 m/s in the dual-region reactor 10 (referred to in the legend of FIG. 7 as the “ICFB”) were selected as a reference, which represent the lowest NO conversion at U_{D}=0.45 m/s and the highest one at U_{D}=1.05 m/s in these examples under these conditions. For O₂=8% and 12%, NO conversion at U_{D}=0.9 m/s was also plotted.

When the dual-region reactor 10 was operated at U_{D}=0.45 m/s, both the dual-region reactor 10 and the conventional fluidized bed reactor showed similar performance with a NO conversion of ˜40% for the emission strea 12 with 4% O₂. When U_{D} increased to 1.05 m/s, the dual-region reactor 10 showed much better performance than the conventional fluidized bed reactor, with the NO conversion similar to, or higher than, that in the conventional fluidized bed reactor operating at even 1% O₂. At U_{D}=0.9 m/s, even the NO conversion recorded using the dual-region reactor 10 at 8% O₂ and 12% O₂ was 10% more than that of the 4% O₂ condition in the convent fluidized bed reactor when U (or U_{A}, the superficial gas velocity in the annulus/adsorption region 14) was lower than 0.4 m/s. These results clearly demonstrate that the dual-region reactor 10 performs better than the conventional fluidized bed reactor when reducing NOx in emission streams containing relatively high O₂ concentrations.

While illustrative embodiments of the invention have been described, it will be appreciated that various changes can be made therein without departing from the scope and spirit of the invention. The invention is therefore to be considered limited solely by the scope of the appended claims.

1. A method for reducing NOx contained in a gaseous emission stream, the method comprising:
(a) passing the emission stream through an adsorption region of a reactor containing a solid adsorption material and contacting the NOx with the adsorption material such that the adsorption material adsorbs at least some of the NOx;
(b) passing a gaseous hydrocarbon stream through a reduction region of the reactor, the reduction region containing a lower concentration of oxygen than the adsorption region;
(c) removing the adsorption material having the adsorbed NOx from the emission stream thereby producing a treated emission stream and transporting the adsorption material having the adsorbed NOx to the reduction region;
(d) contacting the adsorption material having the adsorbed NOx and the hydrocarbon stream in the reduction region such that the adsorbed NOx is catalytically reduced by a catalytic material and the adsorption material is regenerated, the catalytic material being at least one of the adsorption material and a separate material that is located in the reduction region; and
(e) returning the regenerated adsorption material to the adsorption region and discharging the treated emission stream from the reactor.

2. A method as claimed in claim 1 wherein the emission stream and hydrocarbon stream are passed vertically upwards through the reactor, and the velocity of the hydrocarbon stream is high enough to carry the adsorption material having the adsorbed NOx upwards through the reduction region, and the velocity of the emission stream is low enough to allow adsorption material having the adsorbed NOx discharged from a top end of the reduction region to fall through the adsorption region and back into a bottom end of the reduction region, thereby removing the adsorption material having the adsorbed NOx from the emission stream and transporting the adsorbed material having the adsorbed NOx to the reduction region.

3. A method as claimed in claim 1 wherein the hydrocarbon stream has a velocity of about 0.4 m/s to about 2.0 m/s and the emission stream has a velocity of about 0.2 m/s to about 0.6 m/s.

4. A method as claimed in claim 1 wherein the emission stream and hydrocarbon stream are passed vertically upwards through the reactor, and the velocity of the emission stream is high enough to carry the adsorption material having the adsorbed NOx upwards through the adsorption region thereby removing the adsorption material having the NOx from the emission stream, and the velocity of the hydrocarbon stream is low enough to allow adsorption material having the adsorbed NOx discharged from the top end of the adsorption region to fall through the reduction region and back into a bottom end of the adsorption region, thereby transporting the adsorbed material having the adsorbed NOx between the adsorption region and the reduction region.

5. A method as claimed in claim 1 wherein the reactor has a temperature of between about 250° C. to about 550° C.

6. A method as claimed in claim 1 wherein the emission stream has an oxygen concentration of between about 2% to about 21%.

7. A method as claimed in claim 1 wherein the hydrocarbon stream comprises a concentration of propylene or other hydrocarbons and the emission stream comprises a concentration of NO, the concentration of propylene or other hydrocarbons being about 1 to about 4 times (V/V) the concentration of NO.

8. A method as claimed in claim 1 wherein the velocity of the emission and hydrocarbon streams do not exceed a velocity which would cause the adsorption material to be discharged from the reactor.

9. A method as claimed in claim 8 wherein the velocity of the emission and hydrocarbon streams are selected so that the oxygen concentration in the reduction region is between 0.5 to 1.5%.

10. A method as claimed in claim 1 wherein the concentration of water vapour and sulphur dioxide are lower in the reduction region than the adsorption region.

11. A reactor reducing NOx contained in a gaseous emission stream, comprising:
(a) a housing having a top end, bottom end, and a side wall interconnecting the top and bottom ends;
(b) a draft tube located inside the housing and spaced from the housing side wall to define an adsorption region therebetween and a reduction region inside the tube, the draft tube having an open top end and an open bottom end;
(c) a distribution plate inside the housing and extending from the side wall and downwards towards the draft tube bottom end;
(d) an emission stream inlet in the housing in gaseous communications with the bottom of the adsorption region such that a gaseous emission stream supplied through the emission stream inlet flows upwards through the adsorption region;
(e) a hydrocarbon stream inlet in the housing and in gaseous communication with the draft tube bottom end such that a gaseous hydrocarbon stream supplied through the hydrocarbon stream inlet flows upwards through the reduction region;
(f) adsorption material inside the housing that circulates between the reduction and adsorption regions when the emission and reduction streams are flowing through the reactor, the distribution plate positioned so that adsorption material falling through the adsorption region are directed towards the draft tube bottom end and into the draft tube by the hydrocarbon stream; and
(g) a reactor outlet located above and in gaseous communication with the draft tube top end and in gaseous communication with the adsorption region.

12. A reactor as claimed in claim 11 further comprising an emission stream distribution chamber under the distribution plate, and wherein the emission stream inlet is in gaseous communication with the emission stream distribution chamber, and the distribution plate has at least one opening therethrough to allow the emission stream to pass from the emission stream distribution chamber to the adsorption region.

13. A reactor as claimed in claim 12 wherein the at least one opening in the distribution plate is located at a height in the reactor above the draft tube bottom end.

14. A reactor as claimed in claim 13 wherein the distribution plate comprises a plurality of openings with a majority of the openings located at a height in the reactor above the draft tube bottom end.

15. A reactor for reducing NOx contained in a gaseous emission stream, comprising:
(a) a housing having a top end, bottom end, and a side wall interconnecting the top and bottom ends;
(b) a draft tube located inside the housing and spaced from the housing side wall to define an reduction region therebetween and adsorption region inside the tube, the draft tube having an open top end and an open bottom end;
(c) a distribution plate inside the housing and extending from the side wall and downwards towards the draft tube bottom end;
(d) a hydrocarbon stream inlet in the housing in gaseous communication with the bottom of the reduction region such that a gaseous hydrocarbon stream supplied through the hydrocarbon stream inlet flows upwards through the reduction region;
(e) an emission stream inlet in the housing in gaseous communications with the draft tube bottom end such that an gaseous emission stream supplied through the emission stream inlet flow upwards through the adsorption region; and
(f) adsorption material inside the housing that circulates between the reduction and adsorption regions when the emission and reduction streams are flowing through the reactor, the distribution plate positioned so that adsorption material falling through the reduction region will be directed towards the draft tube bottom end and into the draft tube by the emission stream; and
(g) a reactor outlet located above and in gaseous communication with the draft tube top end and in gaseous communication with the reduction region.
